(19) United States
(12) Patent Application Publication
(10) Pub. No.: US 2010/0083845 A1
(43) Pub. Date: Apr. 8, 2010

(54) STEAM GENERATOR COOKING DEVICE METHOD FOR OPERATING AND PRODUCING A STEAM GENERATOR AND METHOD FOR COOLING A HEATING DEVICE

(75) Inventors: Volker Block, Bretten (DE); Michael Riffel, Oberderdingen (DE); Christian Seidler, Bretten (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E.G.O. Elektro-Geraetebau GmbH

(21) Appl. No.: 12/634,987

(22) Filed: Dec. 10, 2009

Related U.S. Application Data
(63) Continuation of application No. PCT/EP2008/004716, filed on Jun. 12, 2008.

(30) Foreign Application Priority Data
Jun. 14, 2007 (DE) 10 2007 029 244.0

(51) Int. Cl. A47J 27/04; F22B 1/28; A47J 27/16

(52) U.S. Cl. 99/330; 392/394; 392/399; 392/403; 126/20; 219/401

(57) ABSTRACT

A steam generator for cooking devices has a vessel and a heating device. Water to be evaporated is contained within a free volume of an inner chamber of the vessel, which forms a water-guiding region. This water is heated through a heating device at least up to boiling temperature, whereby steam is generated that flows along a steam-guiding region of the vessel. The heating device is a thick-film heating device applied to the surface area of the vessel on the water-guiding region. Both the water and the steam flowing past cool the heating device as the water level drops.

### CROSS REFERENCE TO RELATED APPLICATIONS

This application is a continuation of PCT/EP2008/004716, filed Jun. 12, 2008, which in turn claims priority to DE 10 2007 029 244.0, filed on Jun. 14, 2007, the contents of which are incorporated by reference.

### BACKGROUND

The invention relates to a steam generator, in particular for a cooking device. The invention also relates to a cooking device with such a steam generator and a method for its operation, a method for its manufacture, as well as a method for cooling of a heating device for such a steam generator.

A steam generator of the afore-mentioned type is known, for instance, from GB 23 77 483 A, which has a boiler comprising an inner chamber that is surrounded by a boiler wall. The boiler inner chamber serves to hold water which is heated by heating wires and then evaporates, whereby the heating wires extend mainly along the entire boiler wall as well as the base of the boiler. A disadvantage of using heating wires to heat the boiler chamber and water present in the boiler chamber is that a considerable amount of the heat energy is lost without being used. This occurs on the one hand in regions in which there is no water to be evaporated and on the other hand because the ratio between water to be evaporated and the surface area directly heated by the heating wires is comparatively low. The response characteristics of such a steam generator device in terms of providing steam are also slower than desired.

### SUMMARY

The problem addressed by the invention is therefore to provide a steam generator, a cooking device with a steam generator, a method for the operation of a heating device for a steam generator, a method for the manufacture of a heating device and a method for the cooling of a heating device for a steam generator, in which the response characteristics of the steam generator in terms of the time required to provide steam are markedly improved and in which the energy efficiency of the heating device used is increased. In addition, if the steam generator runs dry this should not present any dangers.

This invention addresses this problem in various embodiments as claimed herein. Advantageous and preferred embodiments of the invention are the subject of further claims and are described in more detail below. The wording of the claims is rendered content of the description through express reference. Some of the following not exhaustively listed properties and characteristics relate both to the devices and the methods. In part they are only described once, but apply independently of one another and in any desired combination both for the method and for the device. The wording of the claims is thereby rendered content of the description through express reference.

In accordance with one embodiment of the invention, the vessel has a water-guiding region for water to be evaporated, whereby the heating device heats the water to be evaporated up to boiling temperature as steam. The steam-guiding region of the vessel guides the steam generated out of the vessel or the steam generated flows along it. The heated area or heating device is provided on the water-guiding region and if necessary also on the steam-guiding region. Although the steam is hotter than the water, its temperature is still markedly below that of the heating device in uncooled operation, i.e., when it is unable to supply energy. The evaporation process or steam generated therefore also cools the vessel at the same time. For this purpose after the steam is generated, it flows in a steam guide along the surface of the heated vessel. As a result, the heating device is cooled and advantageously such that it is ensured that the heating device has a substantially constant temperature during the evaporation process, despite the falling water level, i.e., near boiling-dry of the vessel. The cooling action of the water in the water guide, i.e., below in the vessel, is then increasingly assumed by the steam, although with a somewhat lower cooling effect, but nevertheless still sufficient to cool the heating device. The temperature of the heating device does not rise until the water in the vessel is almost completely evaporated, since the steam quantity then present in the steam guide falls, and with this its cooling effect. The temperature rise of the heating device then brings about a change in the physical properties of the heating device which is preferentially simple to measure, for instance, using a change in its electrical resistance.

In principle, the steam generator can operate with any desired liquid. Preferentially, it operates with water and evaporates water, in particular tap water.

With a steam generator described above, it is advantageous for the heating device to have a relatively low mass and it is especially advantageous if a thick-film heating device is applied to one surface of the vessel. An advantage of using a thick-film heating device as a heating device is that the entire steam generator only requires a comparatively small installation space. The thick-film heating device may be applied to the surface of the vessel, for instance, through a printing process, so that a direct bodily contact exists between the thick-film heating device and the surface. The transfer of the heat energy generated by the thick-film heating device to the vessel therefore does not have to overcome any further transfer medium. As an alternative, tubular heating bodies may be used, in particular tubular heating bodies that have a thin wall and/or low mass.

The heating device used can, for instance, also be used as a temperature sensor or as a fill-level sensor. The direct attachment of a heating device, for instance a thick-film heating device, to the vessel results in substantially uniform transfer of the heat energy generated by it into the vessel to be heated and transfer directly from the material of the vessel into the water to be evaporated. The heat energy that is manifested in the higher temperature of the vessel is distributed in this process in the vessel, at least in one region of the vessel with the heating device, i.e., in the water-guiding region. The heat energy evaporates the water over the course of time.

The steam generator according to the invention is preferentially used in cooking devices. Such cooking devices are, for instance, so-called steamers, in which a food to be cooked is mainly cooked solely through hot steam. For steaming it is naturally an advantageous if the water to be evaporated is mostly heated up to boiling temperature. However, heating of the water to be evaporated up to boiling temperature is, for instance, not necessary if the steam generator is to be used to create a comparatively moist atmosphere in a cooking device to prevent the food to be cooked from drying out. It is, for example, also conceivable for the steam generator according to one embodiment of the invention to be used in a baking device in which the air present is saturated with steam from the steam generator so that the air present in the baking device cannot draw further moisture out of the product being baked. In general, the steam generator according to the invention may be used or applied in many different ways.

A vessel within the scope of the invention is any device into which a volume of water can be filled such that it can be sufficiently well heated through the heating device for use within the scope of the invention. The water volume is naturally contained in the inner chamber of the vessel. A heating device within the scope of the invention is advantageously a thick-film heating device, whereby additional other heating devices may also be provided.

One object of the invention is also achieved through a generic steam generator in which the inner chamber of the vessel, in particular the water-guiding region and advantageously also the steam-guiding region, has a section of a displacement body to reduce the free volume. The displacement body can substantially have any desired form and naturally also substantially any desired volume.

The displacement body extends into the inner chamber of the vessel in the water-guiding region with the water present in it during the evaporation process. In this way the maximum volume available to hold the water to be evaporated is markedly reduced in this particular region so that the ratio between the external surface area and the volume of the water to be evaporated changes in favour of the external surface area. An advantageous result of this configuration is that markedly less time is required for evaporation or heating of the water to be evaporated up to the boiling temperature and consequently requires less energy overall. In addition, the response characteristics of the steam generator are markedly improved; namely the time between switching the steam generator on and attainment of the boiling temperature or a desired temperature of the water to be evaporated is reduced.

In another embodiment of the invention, the displacement body has an outer contour that extends substantially parallel to the inner contour of the vessel or has a corresponding similar course. This embodiment of the displacement body can result in a substantially annular volume of the water to be evaporated. If the displacement body is arranged in an especially preferred manner such that it is aligned substantially co-axially to the vessel, then an annular volume of a substantially constant width results between the inner contour of the vessel and the outer contour of the displacement body. This width may be just a few millimetres, i.e., very little. The heat energy to be introduced into the water to be evaporated for the evaporation process can in this manner be particularly uniformly distributed.

The displacement body may also either have an uneven outer contour or be arranged such that the width of the annular volume varies over the course of the ring, i.e., is comparatively small in one region and comparatively large in another region. In this way, for example, the response characteristics of the steam generator can be improved further since in the region with a particularly small width of the annular volume the water to be evaporated will reach boiling temperature even more rapidly.

In another embodiment of the invention, the displacement body is a hollow body. In a further embodiment of the invention, the displacement body is in the form of a tube, preferably a vertically positioned tube, wherein a lower end region of the tubular displacement body is connected to one surface of the internal chamber, in particular in a water-proof manner. A hollow body within the meaning of the invention is any body in which a recess is provided. A hollow body can also have the form of a beaker, have a tubular shape, or for instance have an inner hollow cube form. The displacement body and the internal chamber can be connected, for instance, through welding or screw connections or the like, whereby the chosen connection should be temperature-resistant and water-tight in all cases. The use of a hollow body as a displacement body allows the weight of the steam generator as a whole to be kept comparatively low and in addition, the area to be heated as a whole has only a low mass. This brings a further energy-savings on the one hand and on the other hand, for example, an improved cooling response of the steam generator, in particular if the displacement body is fabricated from metal.

A tubular arrangement of the displacement body enables comparatively inexpensive manufacture of the displacement body since, for example, a tube commonly available commercially can be used for manufacture. It is merely necessary to separate a section of this tube of a certain length and to position and attach it within the inner chamber of the vessel.

In another embodiment of the invention, the vessel is substantially of beaker shape and the heating device is arranged, at least in part, in one region of the outer surface area of the vessel, in one region of a base area of the vessel, and/or in one region of an inner and/or outer surface area of a displacement body arranged in the vessel. In an especially advantageous manner it covers at least the entire water-guiding region. The heating device is advantageously arranged such that it does not come into direct contact with the water, in so far as an electrically-operated heating device is used. The heating device can alternatively be arranged on the internal side of the vessel or on the external side of the displacement body, i.e. in the water. In such a case it must be insulated or covered by an insulating layer.

The described possibilities of arrangement of the heating device on the described areas of the vessel or on the displacement body are preferentially comparatively small areas and preferentially coincide at least in their projection with the water present in them. This arrangement can advantageously bring energy savings as only those regions have to be heated in which water to be evaporated is present.

In another embodiment of the invention, the heating device is arranged in one lower region of the vessel and thus also the water-guiding region. The steam-guiding region may be joined directly onto this. In particular, it increases in size where the water-guiding region recedes with falling water level. In this way the vessel can in the main be dried out fully after it has been used for steam generation. This avoids the build-up of microbial colonies or the like in wet places which would possibly remain if there were no possibility of subsequent heating.

In another embodiment of the invention, the heating device envelops the vessel in the region of its surface area at least over sections. The heating device is thereby arranged distributed over the surface area of the vessel such that a uniform heating of the vessel or the water contained in the vessel is ensured.

In another embodiment of the invention, the ratio between the diameter of the vessel and the height of a region of the vessel covered by the heating device/heat conductors lies between 0.25 and 10, in particular between 1 and 5. In a further embodiment of the invention, the height of the region covered by the heating device is substantially a minimum fill height of the vessel or the water-guiding region for the start of operation. The aforementioned choice of the ratio between the diameter and height/minimum fill height of the vessel enables pre-determination of the best efficiency of the steam generator for the particular application. In particular, the height of the heating device which substantially corresponds to the minimum fill height of the vessel brings an energy-saving upon operation of the steam generator since only those regions that contain water are heated.

In another embodiment of the invention, the heating device is a fill level sensor for the water to be evaporated in the vessel and/or a temperature sensor, whereby preferentially the steam generator has a control device for the evaluation of a sensor signal emitted by the sensor. In a further embodiment of the invention the heating device has a positive temperature coefficient. The arrangement of the heating device with a positive temperature coefficient, i.e., as a PTC thermistor, enables the heating device to be used in a simple manner as a temperature sensor since the resistance of the heating device also rises with an increase in temperature. The use of the heating device as a fill level sensor functions substantially according to the same principle since the temperature of the heating device can rise by a small amount in regions in which no more water to be evaporated is present.

The heating device can be divided into individual heating regions, for instance into strips that run substantially parallel to each other, for fill level recognition, however, not only for this purpose. These strips can then be arranged preferentially mainly parallel to the course of the fill level planes so that a falling or rising fill level upon falling/rising liquid level will sequentially pass the individual strips. With a corresponding form of the vessel, the heat output generated by the individual strips is transferred to the water to a greater or lesser degree, depending on whether the strips lie below or above a fill level line for the actual fill level. If a strip is arranged above the fill level line, then it will heat up more, so that inferences can be drawn on the fill level of the steam generator from the rise in temperature of the heating device in different regions.

The power per unit surface area of the heating device is advantageously greater than 20 W/cm², and is particularly advantageously between 25 W/cm² and 75 W/cm². The power per quantity of water in the vessel without the aforementioned displacement body can be approximately 10 W/ml and with the displacement body approximately 30 W/ml to 100 W/ml.

The aim of the invention can also be achieved through a cooking device with a steam generator, whereby the cooking device is a steam cooker. Such steam cookers are, as already mentioned above, known as steamers.

A further embodiment of the invention is a method for the operation of a heating device for a steam generator, whereby a temperature of the water to be evaporated and a temperature of the heating device are established. The status of the steam generator is determined from the temperature values established, in particular through the use of a control device. The temperature of the water to be evaporated can, for instance, be established through an additional temperature sensor that can function independently of the heating device or the temperature determination by means of the heating device. The status of the steam cooker which is determined by the aforementioned method in particular affects the degree of calcification of the evaporator. This can be determined, for instance, by monitoring the efficiency of the heating device. This efficiency is determined by the temperature of the heating device, the change in temperature of the heating device, the temperature of the water and the change in temperature of the water to be evaporated. If the time required for the water to reach a certain temperature is comparatively long with the temperature of the heating device substantially remaining the same, then this is generally a clear indication of the advanced calcification of the steam generator since a layer of lime is a comparatively good heat insulator. This necessitates comparative measurements with a full water level to establish how the time required to reach a certain temperature changes. A signal may be sent to an operating person with a request to carry out descaling. As an alternative, or additionally, an anti-adhesion coating may prevent or reduce the build-up of lime.

The changing degree of calcification can be established, for instance, through the use of a corresponding control device, whereby this control device can emit a corresponding signal. Such a control device can, for instance, be a microprocessor, a programmable controller, an electronic component arrangement or the like. The control unit can be a separate component assigned solely to the steam generator. It is, however, also possible for the aforementioned control unit to be a part of a control unit, for instance for a steam cooker, in which the steam generator according to the invention is arranged.

In another embodiment of the invention, the fill level of a steam generator is detected through the electrical resistance of the heating device. In a further development of the invention the heating device is switched off if the resistance of the heating device exceeds a pre-set value and the current/power falls below a certain value. In this way it can be ensured that the heating device does not overheat and is therefore substantially protected against burn-through.

One object of the invention is further attained through a method for the manufacture of a heating device for a steam generator, in which the heating device is applied to a surface of the vessel as a thick-film heating device, through a printing process, in particular a silkscreen printing process. The use of a silkscreen printing process to apply thick-film components to a substrate is a generally known and mastered technology. The manufacture of a thick-film heating device according to the invention is simplified in this way and a comparatively high quality standard is guaranteed.

A method for cooling a heating device of a steam generator is also possible through the invention. In accordance with this embodiment, the method the heating device is cooled in a region through steam passing by the heating device, in particular if the water to be evaporated is evaporated to the extent that its surface lies below an upper edge of the heating device. The water-guiding region then decreases in size with the water level and the steam guiding region extends increasingly in a downward direction to cool the heated regions/the heating device.

These and further characteristics are evident from the claims and also from the description and the drawings, whereby the individual characteristics can be realized on their own or in the form of sub-combinations with an embodiment of the invention and in other areas and can represent advantageous and protectable embodiments, for which protection is claimed here. The subdivision of the application into individual sections and intermediate headings does not restrict the general applicability of the statements made thereunder.

### BRIEF DESCRIPTION OF THE DRAWINGS

Different embodiments of the invention are shown schematically in the drawings and described in more detail below. The embodiments shown in the individual figures in part have characteristics that the other embodiments shown do not have. The individual characteristics can, however, be combined with each other in any desired manner without exceeding the boundaries of the invention. The drawings show the following:

FIG. 1 A sectional view of a steam generator according to the invention in accordance with a first embodiment with a displacement body arranged in the steam generator and a heating device,

FIG. 2 A sectional view of a steam generator according to the invention in accordance with a second embodiment with a displacement body and a plurality of heating devices arranged in the steam generator,

FIG. 3 A sectional view of a steam generator according to the invention in accordance with a third embodiment with a heating device and a plurality of temperature sensors arranged on the steam generator, and

FIG. 4 A cooking device with the steam generator according to the invention.

### DETAILED DESCRIPTION OF THE DRAWINGS

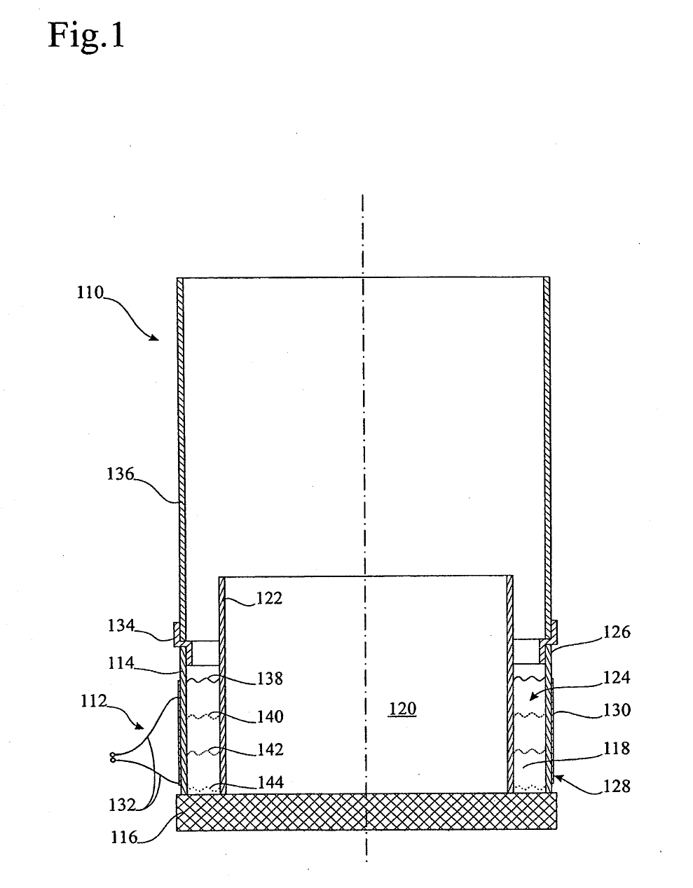

A steam generator 110 shown in FIG. 1 has a vessel 112 that is formed from a tube section 114 and a base element 116. The vessel 112 is formed to hold water to be evaporated 118. A displacement body 120 is arranged in the vessel 112 and is formed from a tubular section 122 in conjunction with a part of the base section 116. The displacement body 120 is substantially coaxial to the vessel 112. The diameter of the tubular section 122 of the displacement body 120 is smaller than the diameter of the tube section 114 of the vessel. This yields an annular region 124 containing the water 118.

A heating device 128 is arranged on an outer surface 126 of the tube section 114. The heating device 128 is in the form of a thick-film heating device 130 and is applied, for instance, through a silkscreen printing process to the tube section 114. The thick-film heating device 130 can be connected through connection devices 132 to mostly any desired control means, not shown in FIG. 1.

The vessel 112 is connected through an adapter ring 134 to a steam tube 136. The steam generated by the steam generator 110 flows through the steam tube 136 to a cooking device or the like, but which is not shown in FIG. 1. The annular region 124 is filled with water to be evaporated 118 for the generation of steam by the steam generator 110. Water is filled preferably from a water feed system, not shown in the Figures, connected directly to the annular region. The minimum fill height of the vessel 112/annular region 124 upon switching the heating device on is indicated in FIG. 1 by an unbroken wavy line 138. The minimum fill height substantially corresponds to the upper edge of the thick-film heating device 130. In the course of the evaporation process for the water to be evaporated 118, the fill height 138 continues to fall if no further water is introduced. The falling fill levels are indicated by different wavy lines 140, 142, 144, whereby the lowest wavy line 144 at the observation level represents the residual fill level with residual water quantity after evaporation.

A control device, not shown, can be used to determine, for instance, the electrical resistance of the thick-film heating device 130, from which the actual averaged temperature of the thick-film heating device 130 can be directly derived. This possibility represents a safety mechanism for the thick-film heating device 130, since its use can avoid overheating and thus destruction of the thick-film heating device 130. It has been found that the temperature of the thick-film heating device 130 can be maintained at a constant value during the evaporation process, provided that the fill level of the annular region 124 lies above the residual fill level 144. This effect is explainable by the fact that the steam which rises on the surface of the tube section 114 along the steam-guiding region cools this tube section 114, as a result of which the thick-film heating device 130 is also cooled. If, however, the fill level falls below the residual fill level 144 indicated by the wavy line, then sufficient steam will no longer be generated to cool the thick-film heating device sufficiently. Its temperature will rise correspondingly, as a result of which, if a PTC thermistor is used as a heating device, the resistance of the thick-film heating device 130 will increase, which can be recorded.

The region with the actual fill height of the water is the water-guiding region in which the thick-film heating device 130 is anyway cooled by the water. The steam-guiding region lies seamlessly above the water-guiding region and the thick-film heating device 130 arranged in it is also cooled by the steam flowing past. It is therefore important for the invention that either the water-guiding region or at least the steam-guiding region is on the heated area with the heating device.

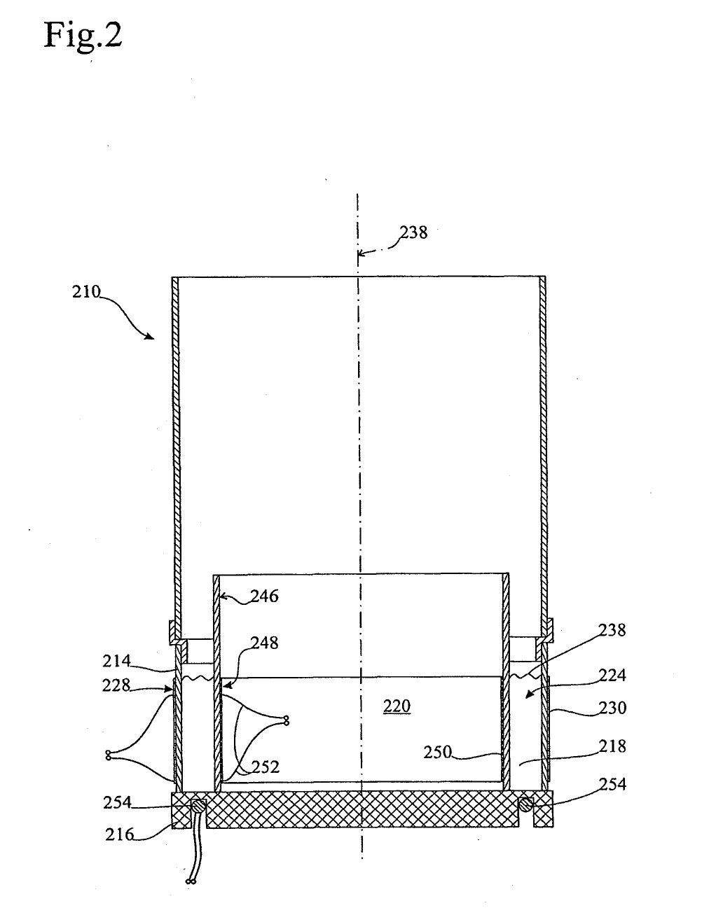

In contrast to FIG. 1, with the steam generator 210 shown in FIG. 2 there is not just a heating device 228 on the tube section 214, there is also a further heating device 248 arranged on an inner surface 246 of the tubular section 222 of the displacement body 220. This heating device 248 is also in the form of a thick-film heating device 250, which is also connected to a control device, not shown, through connection devices 252. The two thick-film heating devices 230, 250 serve to heat the annular region 224 with the water to be evaporated 218. The provision of the second thick-film heating device 250 markedly improves the response behaviour of the steam generator 210 in terms of preparation time that in particular passes between switching on the steam generator and the supply of steam, since a markedly greater heat output per unit volume of water to be evaporated 218 is available.

A third heating device 254 is also shown in FIG. 2 and is arranged in the base section 216 of the steam generator. The heating device 254 can substantially have any desired form. However, it is preferentially substantially annular, as are the other heating devices 228, 248, i.e., it envelops a central longitudinal axis 256 of the steam generator radially. A specially preferred arrangement is one in which the heating devices 228, 248, 254 are arranged coaxially to one another. The heating device 254 is mainly used to remove residual liquid to be evaporated 218 from the annular region 224 after operation of the steam generator is concluded. This prevents the development of microbial colonies. However, the heating device 254 may also be used during the normal evaporation mode operation of the steam generator 214. The problem of the residual water quantity can also be solved or rendered less problematic through the use of a convex base or a base that is displaced upwardly on the inside.

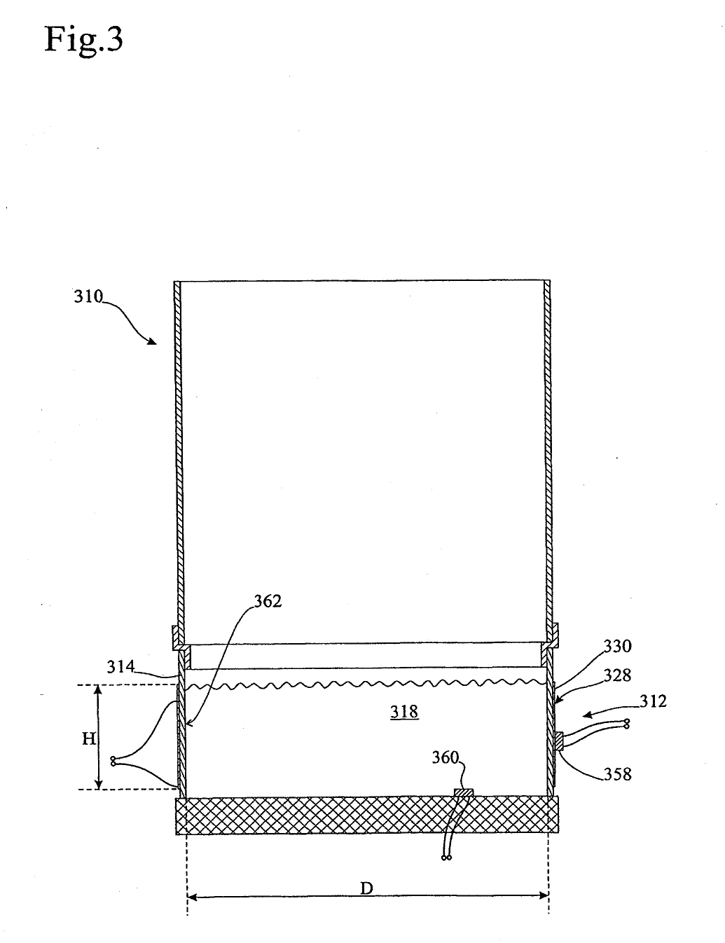

The steam generator 310 shown in FIG. 3, in contrast to the steam generators shown in FIGS. 1 and 2, does not have a displacement body. Consequently, a thick-film heating device 330 of the steam generator 310 has to heat a large volume of water to be evaporated compared to the volumes of water shown in FIGS. 1 and 2, until a sufficient quantity of steam is available or can be generated. With the steam generator 310 shown in FIG. 3, however, a first temperature sensor 358 for the thick-film heating device 330 and a second temperature sensor 360 for the water to be evaporated 318 are additionally provided. Both temperature sensors 358, 360 are connected to a control unit, not shown. This may be separate, or a part of a control unit of the heating device or cooking device. The temperature sensors 358, 360 allow, for instance, the degree of calcification of the steam generator 310 to be established, especially that of the vessel 312. If, for example, a time interval is required for attainment of the boiling temperature of the water to be evaporated 318 that is longer than a pre-specified time interval, whereby the temperature sensor 360 is provided for recognition of the boiling temperature of the water to be evaporated 318, then this is an indication that there is insufficient heat output available. One possible reason for this is that the heating device 328, in this case the thick-film heating device 330, is malfunctioning. It may also be an indication that the transfer of the heating power of the thick-film heating device 330 into the water to be evaporated is not taking place to the desired degree. The transfer of the heating power can, for example, be prevented by a lime layer on the inner surface 362 of the tube section 314. It is possible to distinguish between these two scenarios through the first temperature sensor 358, since this allows inferences to be drawn about whether the heating device 328 is functioning within desired, or pre-specified, parameter limits.

It can further be seen from FIG. 3 that a diameter D of the vessel 312 is in a particular ratio to a height H of the heating device 328 and thus to the heated area, namely between 1:4 and 10:1.

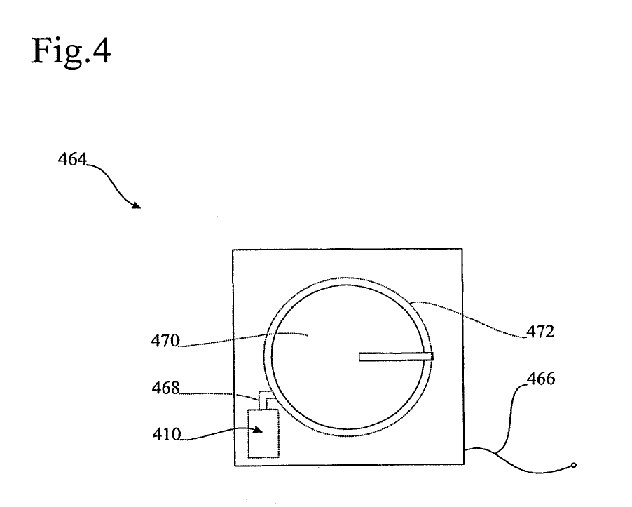

The cooking device 464 shown in FIG. 4 is provided with a steam generator according 410 to the invention. The cooking device 464 is in the form of a so-called steamer, but may also be any other cooking device in which steam is used to cook food, or a similar use. The cooking device 464 is connected through connection lines 466, shown only schematically, for instance to an electricity network and/or a water network. Emanating from the steam generator 410 is a channel 468 to guide steam into a cooking chamber 472 of the cooking device 464 that can be closed through a door 470.

1. A steam generator for a cooking device, with at least one heating device and at least one vessel with a heated area on said vessel, wherein said vessel has a water-guiding region for water to be evaporated, wherein said heating device is configured to heat said water to be evaporated up to its boiling temperature to become steam and wherein said vessel has a steam-guiding region to configured to guide said generated steam out of said vessel and to channel a flow of said generated steam, wherein said heated area comprising a thick-film provided on said water-guiding region and also on said steam-guiding region.

2. A steam generator for a cooking device, with at least one heating device and at least one vessel with a heated area on said vessel, wherein said vessel has an inner chamber and a water-guiding region for water to be evaporated, wherein said heating device is configured to heat said water to be evaporated up to its boiling temperature to become steam and wherein said vessel has a steam-guiding region configured to guide said generated steam out of said vessel and to channel a flow of said generated steam, wherein a displacement body is arranged in said inner chamber of said vessel to reduce a free volume in said inner chamber, wherein said displacement body has an outer contour that extends substantially in parallel to an inner contour of said vessel and said outer contour has a corresponding similar form to said vessel.

3. The steam generator according to claim 2, wherein said heating device is a thick-film heating device.

4. The steam generator according to claim 3, wherein said heating device is applied to only one inner or outer surface area of said vessel.

5. The steam generator according to claim 2, wherein said displacement body is a hollow body in tubular form, wherein one lower end region of said tubular displacement body is fixed to a surface of said inner chamber.

6. The steam generator according to claim 2, wherein said vessel has a substantially beaker-like form and wherein said heating device is configured at least partly in one region of an outer surface area of said vessel, in one region of a base area of said vessel or in one region of an inner or outer surface area of a displacement body arranged in said vessel.

7. The steam generator according to claim 6, wherein said heating device is configured in one lower wall region of said vessel, wherein said heating device envelops said vessel in said region of said surface area of said vessel at least partly and thus defines said water-guiding region.

8. The steam generator according to claim 7, wherein a ratio between a diameter of said vessel and a height of a region of said vessel covered by said heating device is between 0.25 and 10, wherein said height of said region covered by said heating device and said water-guiding region substantially defines a minimum fill height of said vessel.

9. The steam generator according to claim 2, wherein said heating device is a fill level sensor for said water to be evaporated in said vessel or a temperature sensor.

10. The steam generator according to claim 9, wherein said steam generator has a control device for evaluation of a sensor signal emitted by said fill level sensor and wherein said heating device has a positive temperature coefficient.

11. The steam generator according to claim 2, wherein a heat output of said heating device is between 25 W/cm² and 75 W/cm².

12. The steam generator according to claim 2, wherein a heat output per water volume in said vessel without said displacement body is approx. 10 W/ml and with said displacement is approx. 30 W/ml to 100 W/ml.

13. A cooking device with said steam generator according to claim 2, wherein said cooking device is a steam cooker.

14. A method for operation of a heating device for said steam generator comprising at least one heating device and at least one vessel with a heated area on said vessel, wherein said vessel has an inner chamber and a water-guiding region for water to be evaporated, wherein said heating device is configured to heat said water to be evaporated up to its boiling temperature to become steam and wherein said vessel has a steam-guiding region configured to guide said generated steam out of said vessel and to channel a flow of said generated steam, wherein a displacement body is arranged in said inner chamber of said vessel to reduce a free volume in said inner chamber, wherein said displacement body has an outer contour that extends substantially in parallel to an inner contour of said vessel and said outer contour has a corresponding similar form to said vessel, comprising the steps of:
measuring a first temperature value of said water to be evaporated;
measuring a second temperature value of said heating device; and
determining from said first and second temperature values a status of said steam generator.

15. A method for operation of a heating device for a steam generator according to claim 14, wherein said status comprises detecting a fill level of said steam generator through an electrical resistance of said heating device.

16. The method according to claim 15, wherein said heating device is switched off when said resistance of said heating device exceeds a specified value or a current or a power output falls below a specified value or if said values undergo a specified relative change.

17. A method for cooling a heating device of a steam generator according to claim 14, wherein said heating device is cooled in a steam-guiding region by steam flowing past said heating device.

18. The method according to claim 17, wherein said heating device is cooled when said water to be evaporated is evaporated to an extent that its surface lies below one upper edge of said heating device.
